(19) United States
(12) Patent Application Publication
(10) Pub. No.: US 2024/0405840 A1
(43) Pub. Date: Dec. 5, 2024

(54) TRANSMIT POWER CONFIGURATIONS AT A PANEL OR BEAM LEVEL

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/697,719

(22) PCT Filed: Dec. 23, 2021
(86) PCT No.: PCT/CN2021/140689

§ 371 Date: Apr. 1, 2024

(51) Int. Cl. H04B 7/06; H04W 52/36

(52) U.S. Cl. CPC H04B 7/06956; H04W 52/365; H04W 52/367

(57) ABSTRACT

In an aspect of the disclosure, a method, a computer-readable medium, and an apparatus are provided. The apparatus may be a user equipment (UE) or a component thereof. The apparatus may include a processing system configured to: determine a Power Management Maximum Power Reduction (P-MPR) value associated with an identifier (ID) of at least one of an antenna panel or a beam, and calculate an output power threshold associated with the ID of the at least one of the antenna panel or the beam based on the P-MPR value. The apparatus may further include a first interface configured to output data for transmission to a network node, the transmission being based on the output power threshold.

### BACKGROUND

### Technical Field

The present disclosure generally relates to communications systems, and more particularly, to configuration of a transmit power that is specific to an antenna panel or a beam for a user equipment (UE) scheduled by a network node.

### INTRODUCTION

Wireless communications systems are widely deployed to provide various telecommunications services such as telephony, video, data, messaging, and broadcasts. Typical wireless communications systems may employ multiple-access technologies capable of supporting communications with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunications standards to provide a common protocol that enables different wireless devices to communicate on a municipal, national, regional, and even global level. An example telecommunications standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunications standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various standards organizations and regulatory entities have imposed limits on a person's exposure to radio frequency (RF) radiation from wireless devices. For example, a specific absorption rate (SAR) limit may be imposed for wireless devices communicating in a sub-6 carrier, such as those devices operating in frequency range FR1 of a 5G New Radio (NR) and/or Long Term Evolution (LTE) radio access network (RAN). Similarly, a maximum permissible exposure (MPE) limit may be imposed upon wireless devices communicating above 6 GHz, such as those devices operating in frequency range FR2, which may include a portion of the electromagnetic spectrum from 24.25 Gigahertz (GHz) to 52.6 GHz, and may be more commonly known as “millimeter wave” (or mmW, mmWave, etc.).

With the high path loss in mmW systems, a higher equivalent isotropically radiated power (EIRP) may be desired. A higher EIRP may be achieved using antenna panel(s) configured to steer a beam in a specific direction. However, such beam steering may concentrate the beam on a person, and exposure to sufficient RF radiation may have some negative effects on the human body. A relatively short distance, between transmitter and human body may mitigate or even avoid the negative effects of RF radiation exposure. However, human tissue within a certain proximity to the transmitter may be at risk for damage when the transmission power of the transmitter is sufficiently great. For example, a person holding a transmitter up to his/her car when engaged in a phone call may risk some negative health effects that may be proportionate to the transmission power used by the transmitter.

One approach to enforcing MPE limits may include statically limiting the power with which the transmitter transmits to a level below that of applicable MPE limits. However, such an approach involves substantial power back-off, thereby reducing the transmitter's effective range. Thus, a need exists for approaches that adhere to applicable MPE limits while still allowing for satisfactory levels of device performance.

In an aspect of the disclosure, a method, a computer-readable medium, and an apparatus are provided. The apparatus may be a user equipment (UE) or a component thereof. The apparatus may include a processing system configured to: determine a Power Management Maximum Power Reduction (P-MPR) value associated with an identifier (ID) of at least one of an antenna panel or a beam, and calculate an output power threshold associated with the ID of the at least one of the antenna panel or the beam based on the P-MPR value. The apparatus may further include a first interface configured to output data for transmission to a network node, the transmission being based on the output power threshold.

In another aspect of the disclosure, another method, another computer-readable medium, and another apparatus are provided. The other apparatus may be a network node or a component thereof. The other apparatus may include a processing system configured to determine an ID of at least one of an antenna panel or a beam to be used for communication with a UE that is configured to apply an output power threshold associated with the ID of the at least one of the antenna panel or the beam based on a P-MPR value associated with the ID of the at least one of the antenna panel or the beam. The other apparatus may further include a first interface configured to output information indicating the ID of the at least one of the antenna panel or the beam for transmission to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a network node and user equipment (UE) in an access network.

FIG. 4 is a diagram illustrating example configurations of output powers for transmissions at a first time and a second time.

FIG. 5 is a diagram illustrating an example of a network node and a UE configured for communication in a millimeter wave (mmW) range of an access network.

FIG. 6 is a call flow diagram illustrating an example communications flow between a network node and a UE.

FIG. 7 is a flowchart illustrating an example of a method of wireless communications at a UE.

FIG. 8 is a flowchart illustrating an example of a method of wireless communications at a network node.

FIG. 9 is a diagram illustrating an example of a hardware implementation for an example apparatus.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer. Various standards organizations and regulatory entities have imposed limits on a person's exposure to radio frequency (RF) radiation from wireless devices. For example, a specific absorption rate (SAR) limit may be imposed for wireless devices communicating in a sub-6 carrier, such as those devices operating in frequency range FR1 of a 5G New Radio (NR) and/or Long Term Evolution (LTE) radio access network (RAN). Similarly, a maximum permissible exposure (MPE) limit may be imposed upon wireless devices communicating above 6 GHz, such as those devices operating in frequency range FR2, which may include a portion of the electromagnetic spectrum from 24.25 Gigahertz (GHz) to 52.6 GHz, and may be more commonly known as “millimeter wave” (or mmW, mmWave, etc.).

With the high path loss in mmW systems, a higher equivalent isotropically radiated power (EIRP) may be desired. A higher EIRP may be achieved using antenna panel(s) configured to steer a beam in a specific direction. However, such beam steering may concentrate the beam on a person, and exposure to sufficient RF radiation may have some negative effects on the human body. A relatively short distance, between transmitter and human body may mitigate or even avoid the negative effects of RF radiation exposure. However, human tissue within a certain proximity to the transmitter may be at risk for damage when the transmission power of the transmitter is sufficiently great. For example, a person holding a transmitter up to his/her car when engaged in a phone call may risk some negative health effects that may be proportionate to the transmission power used by the transmitter.

One approach to enforcing MPE limits may include statically limiting the power with which the transmitter transmits to a level below that of applicable MPE limits. However, such an approach involves substantial power back-off, thereby reducing the transmitter's effective range. Thus, a need exists for approaches that adhere to applicable MPE limits while still allowing for satisfactory levels of device performance.

The present disclosure provides various techniques and solutions for enforcing MPE limits while providing for device communications and performance that exceeds some other approaches, such as statically limiting transmission power. In particular, the present disclosure describes a user equipment (UE) configured to determine a Power Management Maximum Power Reduction (P-MPR) value associated with an identifier (ID) of at least one of an antenna panel or a beam, and calculate an output power threshold associated with the ID of the at least one of the antenna panel or the beam based on the P-MPR value. The UE may be further configured to output data for transmission to a network node, with the transmission being based on the output power threshold.

### Example Wireless Communications Systems and Access Networks

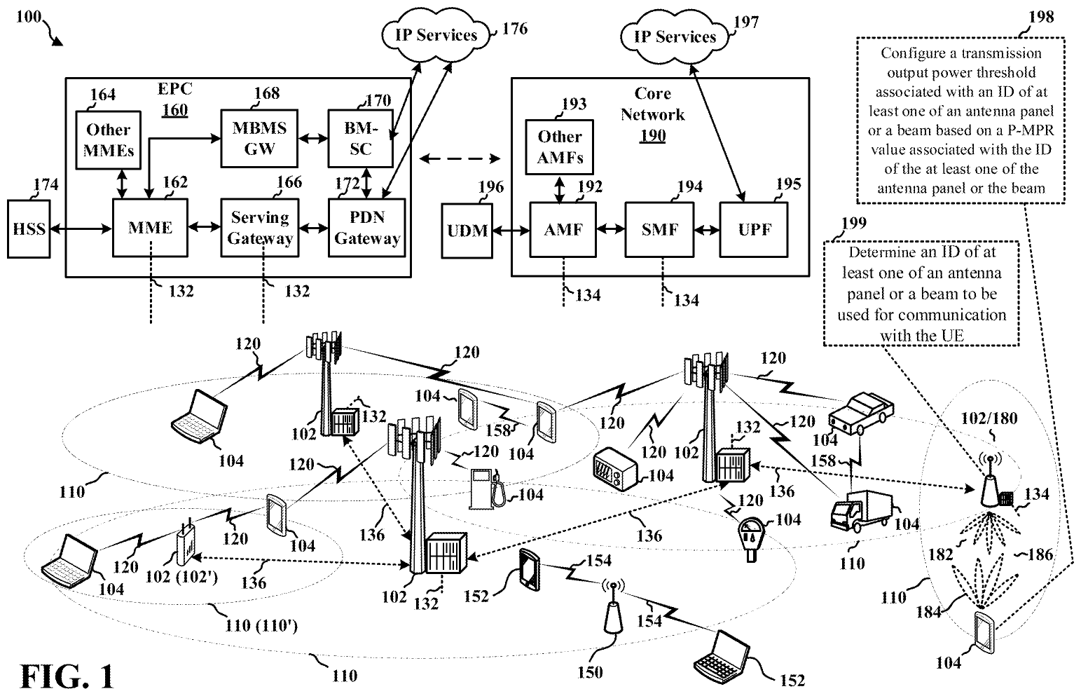

FIG. 1 is a diagram illustrating an example of a wireless communications system and an access network 100. The wireless communications system (also referred to as a wireless wide area network (WWAN)) includes network nodes 102, UE(s) 104, an Evolved Packet Core (EPC) 160, and another core network 190 (e.g., a 5G Core (5GC)). The network nodes 102 may include macrocells (high power cellular base station) and/or small cells (low power cellular base station). The macrocells include base stations, NodeBs, and other similar network nodes. The small cells include femtocells, picocells, microcells, and other similar network nodes.

The network nodes 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The network nodes 102 configured for 5G NR, which may be collectively referred to as Next Generation RAN (NG-RAN), may interface with core network 190 through second backhaul links 134. In addition to other functions, the network nodes 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the network nodes 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the network nodes 102 may be configured for integrated access and backhaul (IAB). Accordingly, such network nodes may wirelessly communicate with other network nodes, which also may be configured for IAB.

At least some of the network nodes 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the network nodes 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the network nodes 102 configured for IAB may be an IAB donor connected through a CU with at least one of the EPC 160 and/or the core network 190. With such a connection to the EPC 160 and/or core network 190, a network node 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the network nodes 102 may be configured with connectivity in an open RAN (ORAN) and/or a virtualized RAN (VRAN), which may be enabled through at least one respective CU, DU, RU, RRH, and/or remote unit.

The network nodes 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the network nodes 102 may provide communications coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro network nodes 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the network nodes 102 and the UEs 104 may include uplink (also referred to as reverse link) transmissions from a UE 104 to a network node 102 and/or downlink (also referred to as forward link) transmissions from a network node 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The network nodes 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a network node at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, the term “sub-6 GHz,” “sub-7 GHZ,” and the like, to the extent used herein, may broadly represent frequencies that may be less than 6 GHZ, frequencies that may be less than 7 GHZ, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A network node 102, whether a small cell 102′ or a large cell (e.g., macro base station), may include and/or be referred to as an eNB, gNodeB (gNB), NodeB, or another type of network node. Some network nodes 180, such as gNBs, may operate in a traditional sub-6 GHz spectrum, in mmW frequencies, and/or near-mmW frequencies in communication with the UE 104. When such a network node 180 (e.g., gNB) operates in mmW or near-mmW frequencies, the network node 180 may be referred to as a mmW network node. The (mmW) network node 180 may utilize beamforming 186 with the UE 104 to compensate for the path loss and short range. The network node 180 and the UE 104 may each include a plurality of antennas, such as antenna elements, antenna panels, and/or antenna arrays to facilitate the beamforming.

The network node 180 may transmit a beamformed signal to the UE 104 in one or more transmit directions 182. The UE 104 may receive the beamformed signal from the network node 180 in one or more receive directions 184. The UE 104 may also transmit a beamformed signal to the network node 180 in one or more transmit directions. The network node 180 may receive the beamformed signal from the UE 104 in one or more receive directions. One or both of the network node 180 and/or the UE 104 may perform beam training to determine the best receive and/or transmit directions for the one or both of the network node 180 and/or UE 104. The transmit and receive directions for the network node 180 may or may not be the same. The transmit and receive directions for the UE 104 may or may not be the same.

In various different aspects, one or more of the network nodes 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the network nodes 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the network nodes 102 belonging to a Multicast Broadcast Single Frequency Network (MBSFN) area broadcasting a particular service, and may be responsible for session management (start/stop) and for collecting eMBMS related charging information.

In some other aspects, one or more of the network nodes 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may configure a transmission output power threshold associated with an ID of at least one of an antenna panel or a beam based on a P-MPR value associated with the ID of the at least one of the antenna panel or the beam (198). For example, the UE 104 may be configured to determine a P-MPR value associated with an ID of at least one of an antenna panel or a beam, and calculate an output power threshold associated with the ID of the at least one of the antenna panel or the beam based on the P-MPR value. The UE 104 may be further configured to transmit data to a network node at a transmission power that is based on the output power threshold.

In certain other aspects, the network node 102/180 may determine an ID of at least one of an antenna panel or a beam to be used for communication with a UE (199), such as the UE 104. The UE 104 may be configured to apply an output power threshold associated with the ID of the at least one of the antenna panel or the beam based on a P-MPR value associated with the ID of the at least one of the antenna panel or the beam. The network node 102/180 may be further configured to transmit information indicating the ID of the at least one of the antenna panel or the beam to the UE 104.

Additional and/or other concepts and aspects related to an output power threshold that is associated with an ID of at least one of an antenna panel or a beam are further described herein. Although the present disclosure may focus on 5G NR, the concepts and various aspects described herein may be applicable to other similar areas, such as LTE, LTE-Advanced (LTE-A), LTE-Unlicensed (LTE-U), License Assisted Access (LAA), code division multiple access (CDMA), Global System for Mobile Communications (GSM), and/or other wireless/radio access technologies.

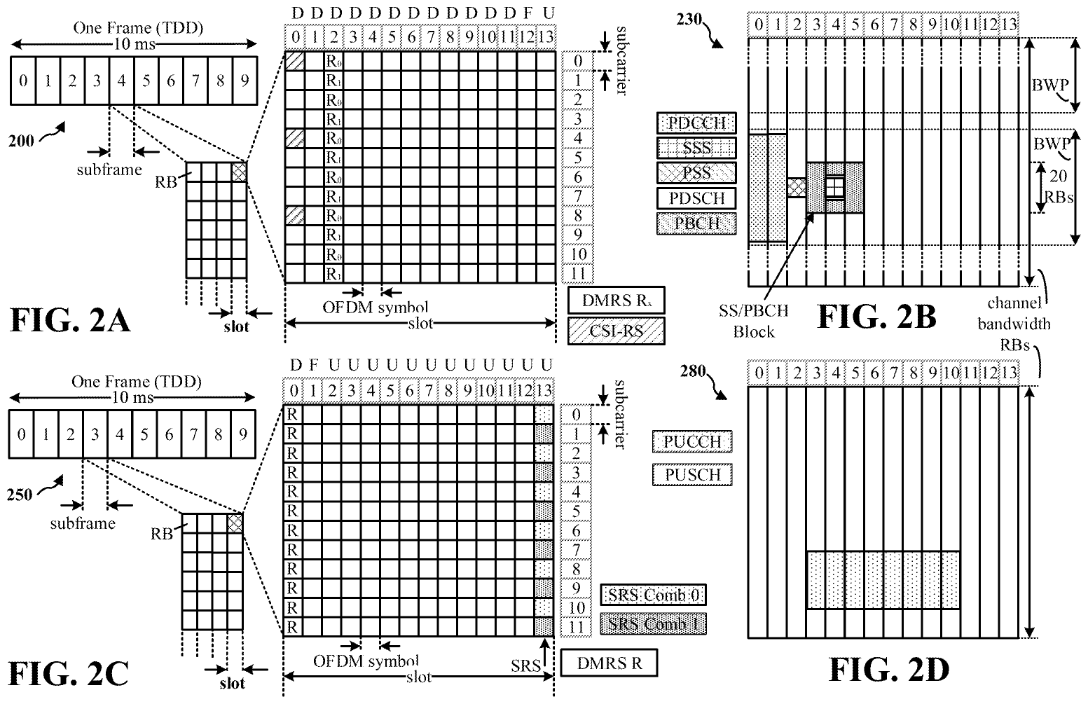

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communications technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at a base station or other network node. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station or another network node for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

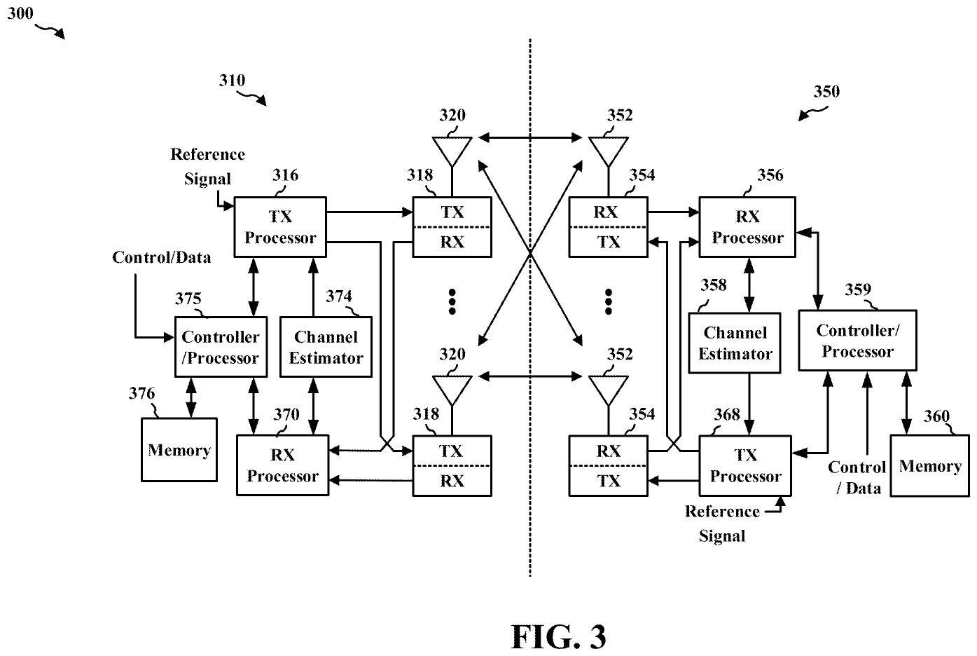

FIG. 3 is a block diagram of a network node 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the network node 310. These soft decisions may be based on channel estimates computed by the channel estimator 358. The soft decisions are then decoded and deinterleaved to recover the data and control signals that were originally transmitted by the network node 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the network node 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the network node 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the network node 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with (198) of FIG. 1.

In some other aspects, at least one of the TX processor 316, the RX processor 370, and the controller/processor 375 may be configured to perform aspects in connection with (199) of FIG. 1.

Aspects Related to a Configured Maximum Output Power Associated with an Antenna Panel or a Beam Having an ID

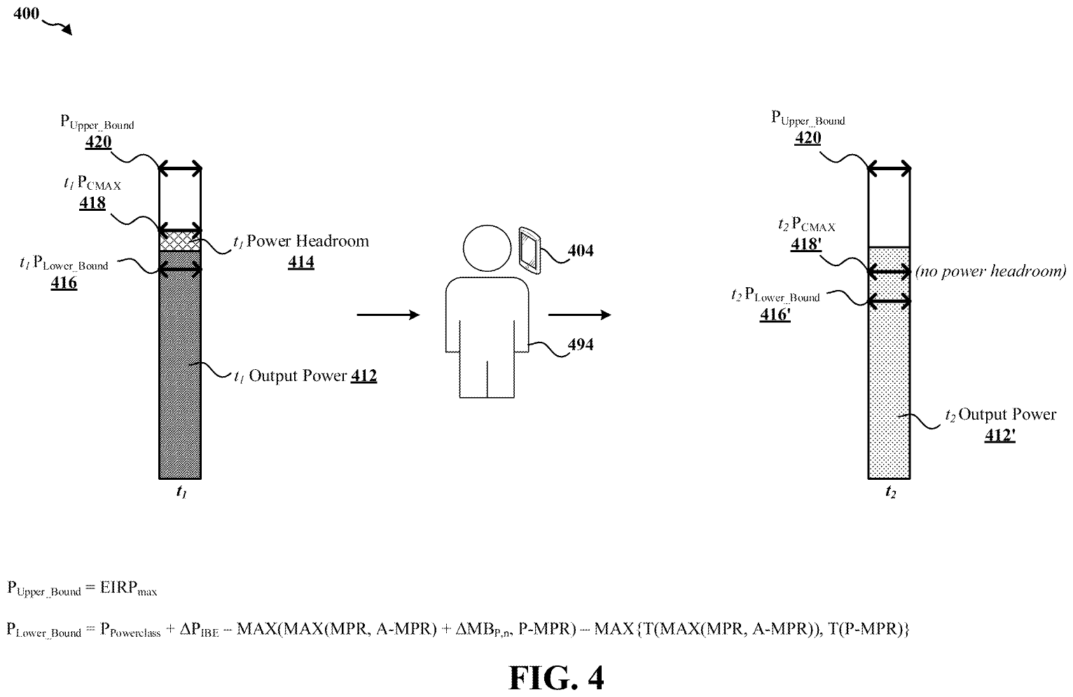

FIG. 4 is a diagram illustrating example configurations 400 of output powers for transmissions at a first time t₁ and a second time t₂. A UE 404 may be configured with a maximum output power P_{CMAX}, which may be a value constrained by an upper bound P_{Upper_Bound} 420 and a lower bound P_{Lower_Bound} 416. The upper bound EIRPₘₐₓ 420 may be equal to the lower value between (1) an EIRPₘₐₓ value provided by a network node (e.g., in a SIB); and (2) a maximum EIRP defined for the power class P_{Powerclass} of the UE 404 and/or the operating band (e.g., n257, n258, n259, etc.).

The lower bound P_{Lower_Bound} 416 may involve more parameters or variables than the upper bound 420. For example, the lower bound P_{Lower_Bound} 416 may be calculated according to the following Equation 1:

$${P}_{Lower Bound} = {P}_{Powerclass} + Δ {P}_{IBE} - MAX ( MAX ( MPR , A - MPR ) + Δ {MB}_{P , n} , P - MPR ) - MAX \{ T ( MAX ( MPR , A ‐ MPR ) ) , T ( P - MPR ) \} \qquad Equation 1$$

In the foregoing Equation 1, P_{Powerclass} may be the power class of the UE 404, ΔP_{IBE} is 1.0 decibel (dB) if the UE 404 supports the parameter maximum power reduction power boost in FR2 (e.g., for Release 16 5G NR), mpr-PowerBoost-FR2-r16, the uplink data transmission by the UE 404 is QPSK, the maximum power reduction MPR is equal to zero (0), network signalling label NS_200 applies, and the network node configures the UE 404 to operate with mpr-PowerBoost-FR2-r16; otherwise, ΔP_{IBE} is 0.0 dB. The maximum output power reduction (MPR) is a maximum amount by which the UE 404 is allowed to reduce output power, and it may be based on modulation order, transmit bandwidth configurations, waveform types, narrow allocations, etc.

The additional MPR (A-MPR) is a maximum power output reduction based on various other factors, such as uplink frequency band, geographical characteristic, and/or uplink transmission bandwidth. The delta value ΔMB_{P,n} is a peak EIRP relaxation parameter in the relevant operating band (e.g., n257, n258, n259, etc.). The function T(ΔP) may be the tolerance in an operating band, e.g., for additional adjustments.

P-MPR may be a power management maximum output power reduction, which may be used to comply with applicable electromagnetic power density exposure requirements, address unwanted emissions, and act in self-defence in case of simultaneous transmissions on multiple RAT(s) or to comply with applicable electromagnetic power density exposure requirements in case of proximity detection.

At time t₁, a network node may schedule a data transmission by the UE 404 on a set of allocated resources. The UE 404 may calculate the maximum output power P_{CMAX} 418 at time ty based on the upper bound P_{Upper_Bound} 420 and a lower bound P_{Lower_Bound} 416, such that P_{Lower_Bound} 416≤t₁ P_{CMAX} 418≤P_{Upper_Bound} 420. The UE 404 may transmit data on the allocated resources at a t₁ output power 412. The ty output power 412 may be a function of the allocated resources (e.g., the number of RBs), the modulation order, the coding rate (e.g., the modulation and coding scheme), and/or other parameters associated with data transmission by the UE 404. The t₁ output power 412 may be less than the t₁ P_{CMAX} 418.

The difference between t₁ P_{CMAX} 418 and the ty output power 412 may be referred to as the power headroom. If certain conditions are met, such as pathloss satisfying a threshold and/or the power headroom satisfying a threshold, then the UE 404 may report the t₁ power headroom 414 to the network node. In response, the network node may allocate additional resources to the UE 404 for a transmission at time t₂, adjust the modulation order, adjust the coding rate, and/or otherwise alter parameters according to which the UE 404 transmits data at 12.

However, between t₁ and t₂, the UE 404 may detect a person 494 (e.g., tissue) is proximate to the UE 404. In some aspects, the UE 404 may include a sensor that senses tissue within a certain distance(s) (e.g., less than twenty inches), and when such tissue is sensed, then the person 494 is considered to be proximate to the UE 404 In response, the UE 404 may calculate (or recalculate) a P-MPR value. The P-MPR value may be adjusted to reduce the risk from RF radiation to the person 494 when the person 494 is proximate to the UE 404.

While the maximum output power P_{CMAX} 418′ at time t₂ is to be reduced due to reduction in the t₂ P_{Lower_Bound} 416′ caused by the t₂ P-MPR value (which may be based on the proximity of a person 494 to the UE 404), the network node may not have been informed yet, and so may schedule the next data transmission by the UE 404 to use parameters that increase the t₂ output power 412′. Potentially, the t₂ output power 412′ may be greater than the t₂ P_{CMAX} 418′, in which case, the UE 404 may transmit at the t₂ P_{CMAX} 418′, which may be the maximum transmission power of the UE 404.

Such a reduction may be inefficient if the beam is not concentrated on the person 494. For example, if the person 494 is not on a line-of-sight (LOS) path with a beam used by the UE 404 to transmit the data transmission, then the likelihood that the person 494 could sustain injuries from RF radiation is very low. However, proximity of the person 494 may be assumed to be applicable to every transmission, but the same power reduction may not be necessary for both a beam pointed at person 494 and a beam pointed away from person 494.

Thus, the present disclosure describes various concepts and aspects in which the P-MPR value and the maximum output power are specific to a beam or an antenna panel corresponding to an ID. For example, a beam ID may be defined by a reference signal ID, a transmit configuration indicator (TCI) ID or TCI state ID, and/or a spatial relation information ID; an antenna panel ID may be defined by an explicit ID (e.g., of the antenna panel) or an implicit ID corresponding to the antenna panel, such as a CORESET pool index, an SRS resource set ID, a TCI group ID, or a closed loop index used for communication via the corresponding antenna panel. Such an arrangement may increase efficiency and reduce latency by allowing a UE to transmit in some scenarios in which a person is proximate to the UE 404 but MPE requirements are overly restrictive in the current context of the UE.

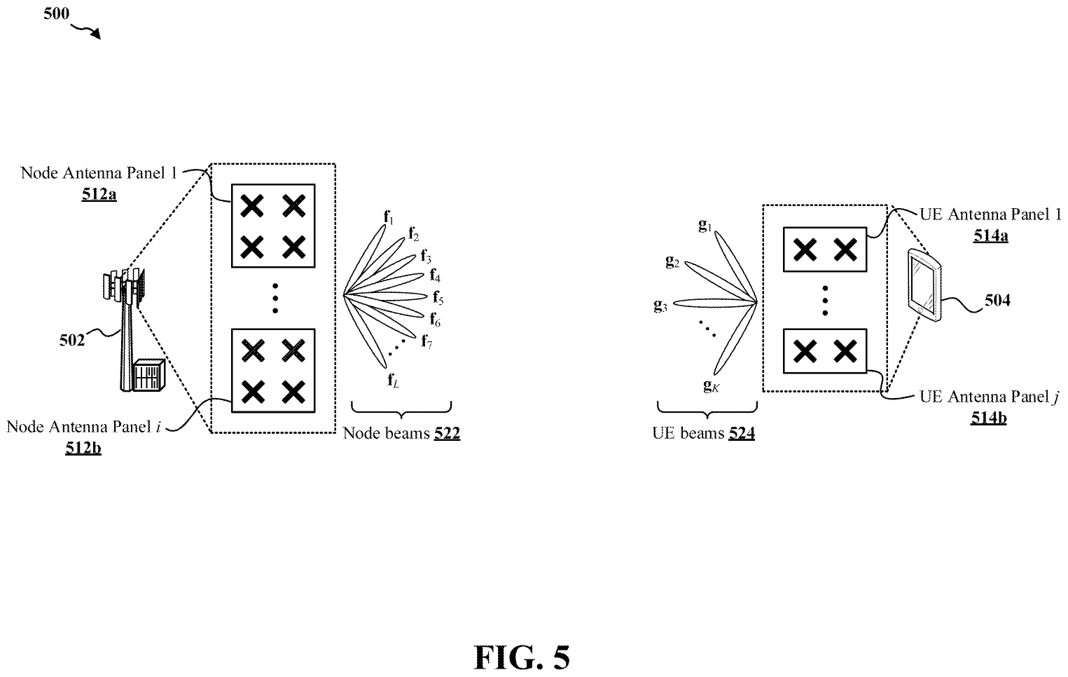

FIG. 5 is a diagram illustrating an example of a network node 502 and a UE 504 configured for communication in a mmW range of an access network 500. The network node 502 and the UE 504 may each include a respective set of antenna panels 512a-512b, 514a-514b (potentially, the UE 504 may have one antenna panel). At a respective one of the network node 502 and the UE 504, the antenna panels may be associated with respective panel IDs, such as a number or other value. For example, the node antenna panels 1-i 512a-512b may be respectively associated with the panel IDs 1, 2, . . . , i. Similarly, the UE antenna panels 1-j 514a-514b may be respectively associated with the panel IDs 1, 2, . . . , j.

For mmW communication, the network node 502 may generate node beams 522 using the node antenna panels 1-i 512a-512b. Each of the node beams 522 may be associated with a beam ID or beam index, which may be known at both the network node 502 and the UE 504. The UE 404 may generate a UE set of beams 524 with which to receive signals transmitted via the node beams 522. Each of the UE beams 524 may be associated with a beam ID or beam index. The beam IDs at the UE 504, however, may not be known at the network node 502.

In some aspects, the beam IDs of the node beams 522 may respectively identified through pilot signals (e.g., SSBs, CSI-RSs, etc.) transmitted on the node beams 522, such as SSB resource indicators (SSBRIs) and/or CSI-RS resource indicators (CRIs). The network node 502 may sweep through the node beams 522 at the network node 502, transmitting each of a first set of pilot signals via each of the node beams 522. The network node 502 may broadcast the first set of pilot signals, such as with SSBs, or the network node 502 may unicast the first set of pilot signals, such as CSI-RSs. The network node 502 may repeat this beam sweeping procedure one or more additional times, so that the network node 502 transmits a respective pilot signal via each of the node beams 522 for each beam sweeping repetition.

In some instances, each set of signals transmitted via the node beams 522 of the network node 502 may be referred to as a “burst.” For example, for a network node 502 that includes a set of four TX beams identified as f₁, f₂, . . . , f_{L}, at burst would include the set of pilot signals transmitted via f₁, f₂, . . . , f_{L} according to a beam sweeping pattern. Other terminology may be used herein to refer to the same or similar concept(s). For example, in the context of a beam sweeping procedure, a “repetition” or an “iteration” may each be used to refer to the sequential transmission of one set of pilot signals according to a beam sweeping pattern.

Correspondingly, the UE 504 may sweep through the UE beams 524 at the UE 504, in order to respectively pair one or more of the UE beams 524 at the UE 504 with node beams 522 at the network node 502. In some aspects, the UE 504 maintains the same UE beam over a burst during which the network node 502 transmits a set of pilot signals via each of the node beams 522. In some aspects, the UE 504 may follow a beam sweeping pattern defining the sequence of UE beams 524 the UE 504 is to use to receive bursts of pilot signals. The beam sweeping pattern followed by the UE 504 may be different from the beam sweeping pattern followed by the network node 502.

For each of the pilot signals received via the UE beams 524, the UE may measure at least one value indicative of a signal strength or a channel quality, such as reference signal received power (RSRP), reference signal received quality (RSRQ), signal-to-noise ratio (SNR), signal-to-interference-plus-noise ratio (SINR), reference signal strength indicator (RSSI), channel quality indicator (CQI), another value indicative of signal strength or channel quality, or any combination thereof. In this way, the UE may find the “best” pairs of node beams 522 and UE beams 524, which may include multipath components that are not necessarily line-of-sight (LoS), particularly in multi-cluster environments with reflective surfaces and/or diffractive sources.

As beam pairs may include differently directed UE beams 524, the lobe(s) of one UE beam in one direction may intersect with a person detected to be proximate to the UE 504, whereas the lobe(s) of another beam in another direction may not. If both beams provide paths to the network node 502 via different node beams 522 or different antenna panels 512a-512b, then communication and device performance may benefit from selecting the other beam that does not intersect the person because a higher P_{CMAX} threshold may be configured.

However, in some existing instances, the P_{CMAX} threshold (or configured maximum output power) and P-MPR value are broadly applied in a carrier f of a serving cell c or, for carrier aggregation (CA), in each carrier of each serving cell configured for CA. According to various aspects of the present disclosure, a P_{CMAX} threshold may be specific to a beam or panel, and may be based on a P-MPR value that is specific to the beam or panel. In other words, the UE 504 may configure a maximum transmission output power that is specific to a beam or an antenna panel based on a P-MPR value that is also specific to the beam or the antenna panel. For example, the UE 504 may configure a maximum transmission output power for beam or antenna panel x in carrier f of a serving cell c based on a P-MPR_{f,c,x} value that is specific to beam or antenna panel ID x in carrier f of serving cell c. Accordingly, P_{CMAXf,c,x} may be a maximum transmission output power that is specific to an antenna panel having ID x or a beam having ID x in carrier f of serving cell c.

As P-MPR_{f,c,x} may be the power management maximum power reduction that is specific to an antenna panel having ID x or a beam having ID x in carrier f of serving cell c, P-MPR_{f,c,x} may be used to find the lower bound of P_{CMAXf,c,x}. Instead of Equation 1, supra, the UE 504 may configure the maximum transmission output power P_{CMAXf,c,x} for a configured antenna panel or beam x in carrier f of serving cell c such that the corresponding measured peak EIRP P_{UMAX,x,f,c} is within the following bounds set by Equation 2:

$${P}_{Powerclass} + Δ {P}_{IBE} - MAX ( MAX ( {MPR}_{f , c} , A - {MPR}_{f , c} ) + Δ {MB}_{P , n} , P - {MPR}_{f , c , x} ) - MAX \{ T ( MAX ( {MPR}_{f , c} , A - {MPR}_{f , c} ) ) , T ( P - {MPR}_{f , c , x} ) \} \leq {P}_{UMAX , f , c , x} \leq {EIRP}_{max , x} \qquad Equation 2$$

Similarly, for carrier aggregation, the UE 504 may configure a total maximum transmission output power based on P-MPR values that are specific to the beam or panel. In other words, the UE 504 may configure a maximum transmission output power that is specific to a beam or an antenna panel based on P-MPR values that are also specific to the beam or the antenna panel. For example, the UE 504 may configure a maximum transmission output power for beam or antenna panel x in y carriers f₁, . . . , f_{y}, of z serving cells c₁, . . . , c_{z} configured for CA for the UE 504 based on P-MPRₓ. P-MPRₓ may be a power management term that the UE 504 determines based on each of the P-MPR_{f,c,x} values that are specific to beam or antenna panel ID x in carriers f₁, . . . , f_{y} of serving cells c₁, . . . , c_{z}. Accordingly, P_{CMAXf,x} may be a maximum transmission output power that is specific to an antenna panel having ID x or a beam having ID x in activated carriers f₁, . . . , f_{y} of serving cells c₁, . . . , c_{z}.

As P-MPRₓ may be the power management maximum power reduction that is specific to an antenna panel having ID x or a beam having ID x in CA, P-MPRₓ may be used to find the lower bound of P_{CMAX,x}. Instead of Equation 1, supra, the UE 504, when configured with a plurality of uplink cells for CA, may configure the maximum transmission output power P_{CMAX,x} for a configured antenna panel or beam x (in all activated cells) such that the corresponding measured peak EIRP P_{UMAX,x} is within the following bounds set by Equation 3:

$${P}_{Powerclass} - MAX ( MAX ( MPR , A - MPR ) + Δ {MB}_{P , n} , P - {MPR}_{x} ) - MAX \{ T ( MAX ( MPR , A - MPR ) ) , T ( P - {MPR}_{x} ) \} \leq {P}_{UMAX , x} \leq {EIRPP}_{max , x} \qquad Equation 3$$

In some aspects, the ID x may identify one of the node beams 522 or the node antenna panels 512a-512b at the network node 502. The beam or panel having ID x may be paired with one or more of the UE beams 524 or UE antenna panels 514a-514b. In some aspects, the network node 502 may configure at least one ID x for the UE 504, assuming the UE capability supports such a configuration.

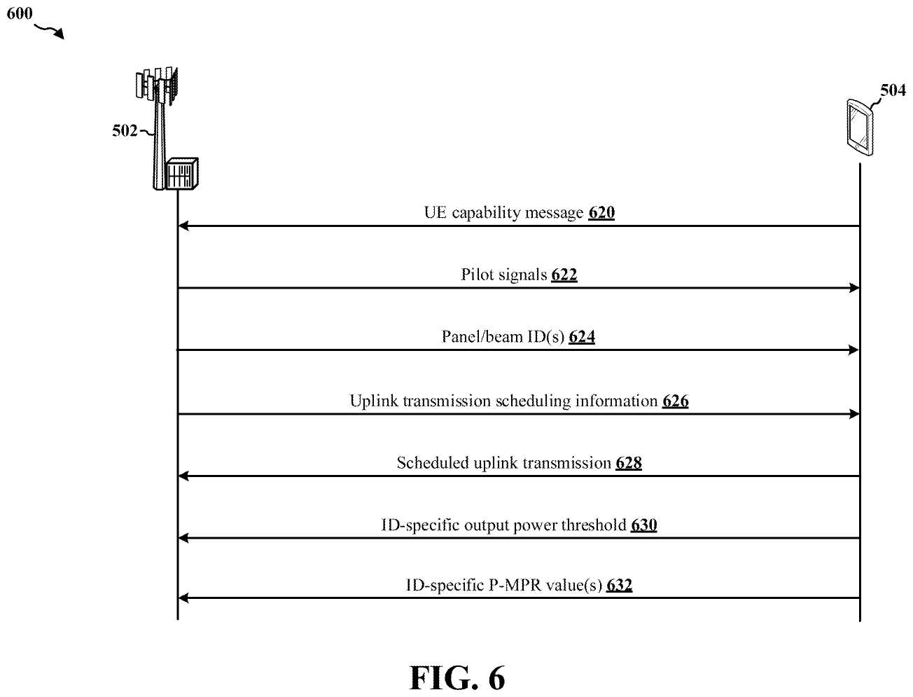

FIG. 6 is a call flow diagram illustrating an example communications flow 600 between the network node 502 and the UE 504. When the UE 504 connects to a RAN, such as during an initial attachment procedure, the UE 504 may transmit information to the network indicating information about the UE 504. This information may be known as a UE capability message 620. The UE capability message 620 may indicate a power class of the UE 504.

As described with respect to FIG. 5, supra, the network node 502 may (periodically) transmit bursts of pilot signals 622 via the node beams 522 generated by the node antenna panels 512a-512b. The UE 504 may receive one or more of the pilot signals 622, and may pair one of the UE beams 524 generated by the UE antenna panels 514a-514b with one of the node beams 522 based on a signal strength (e.g., RSRP) or other metric with which one of the pilot signals 622 is received.

Each of the pilot signals 622 may be associated with a resource indicator, such as an SSBRI or a CRI. A resource indicator may correspond to an ID of one of the node beams 522, e.g., so that the UE 504 may store information indicative of the node beams 522 respectively paired with the UE beams 524. Potentially, up to M resource indicators may be supported for each P-MPR value. For example, the network node 502 may use one of the antenna panels 512a-512b to transmit pilot signals 622 having multiple resource indicators, in which case the multiple resource indicators may correspond to the same antenna panel ID.

In some aspects, the network node 502 may configure the UE 504 with information indicative of an ID for which the UE is to determine a P-MPR value. Therefore, the network node 502 may transmit ID information 624 indicating at least one panel ID or beam ID. The network node 502 may transmit the information 624 indicating the at least one panel ID or beam ID via RRC signaling. In some aspects, the ID information 624 indicating the at least one panel ID or beam ID may include at least one resource indicator, which may correspond to the at least one panel ID or beam ID.

In some further aspects, the ID information 624 indicating the at least one panel ID or beam ID may include a pool of candidates from which the UE 504 may select for reporting P-MPR values and/or P_{CMAX} thresholds. In still other aspects, the ID information 624 may indicate a number of P-MPR values to report and/or the supported number of resource indicators for each P-MPR value.

In some aspects, the network node 502 may schedule a transmission by the UE 504. Accordingly, the network node 502 may transmit uplink transmission scheduling information 626 to the UE 504. The scheduling information 626 may indicate a set of resources allocated to the UE 504 for uplink transmission, a modulation order, a coding rate, and/or other information according to which the UE 504 may transmit signals to the network node 502.

The UE 504 may determine the scheduled output power with which to transmit the scheduled uplink transmission 628 based on the scheduling information 626. For example, the UE 504 may calculate the scheduled output power that the network node 502 expects the UE 504 to use to transmit the scheduled uplink transmission 628 based on a number of allocated resources (e.g., a number of allocated RBs), a modulation and coding scheme (MCS), and/or other parameters associated with the scheduled uplink transmission 628.

Further, the UE 504 may determine a panel ID or a beam ID x with which the UE 504 is configured for panel- or beam-specific power management. For example, the UE 504 may determine (e.g., select, identify, etc.) one of UE antenna panels 514a-514b and/or UE beams 524, paired with a configured antenna panel of node panels 512a-512b or a configured beam of node beams 522, that is not occluded by a person (or tissue) or is least proximate to a detected person. The UE 504 may determine the ID of the configured antenna panel or beam having the ID x, e.g., based on the paired UE antenna panel and/or UE beam.

In some aspects, the UE 504 may determine at least one P-MPR_{f,c,x} value that is specific to the panel or beam having ID x in carrier f of serving cell c. The UE 504 may find the lower bound of a P_{CMAXf,c,x} threshold specific to the panel or beam having ID x in carrier f of serving cell c based on the P-MPR/cx value that is specific to the panel or beam having ID x in carrier f of serving cell c, e.g., as shown in Equation 2, supra. The UE 504 may calculate the P_{CMAXf,c,x} threshold specific to the panel or beam having ID x in carrier f of serving cell c based on the lower bound, which may result in a reduction in the P_{CMAXf,c,x} threshold based on the P-MPR_{f,c,x} value specific to the panel or beam having ID x in carrier f of serving cell c.

In some other aspects, such as those in which the UE 504 is configured with a set of activated cells for CA, the UE 504 may determine at least one P-MPR_{,x} value that is specific to the panel or beam having ID x (e.g., in all of the carriers f₁, . . . , f_{y} of all of the serving cells c₁, . . . , c_{z} activated for CA). The UE 504 may find the lower bound of a P_{CMAX,x} threshold specific to the panel or beam having ID x (e.g., in all of the carriers f₁, . . . , f_{y} of all of the serving cells c₁, . . . , c_{z} activated for CA) based on the P-MPR . . . value that is specific to the panel or beam having ID x in carrier f of serving cell c, e.g., as shown in Equation 3, supra. The UE 504 may calculate the P_{CMAX,x} threshold specific to the panel or beam having ID x (e.g., in all of the carriers f₁, . . . , f_{y} of all of the serving cells CI, . . . , c_{z} activated for CA) based on the lower bound, which may result in a reduction in the P_{CMAX,x} threshold based on the P-MPR_{,x} value specific to the panel or beam having ID x (e.g., in all of the carriers f₁, . . . , f_{y} of all of the serving cells c₁, . . . , c_{z} activated for CA).

The UE 504 may compare the scheduled output power that the network node 502 expects the UE 504 to use to transmit the scheduled uplink transmission 628 to the calculated maximum transmission output power threshold P_{CMAXf,c,x} or, for CA, P_{CMAX,x}. If the scheduled output power is less than or equal to the calculated maximum transmission output power threshold P_{CMAXf,c,x} or, for CA, P_{CMAX,x}, then the UE 504 may use the scheduled output power to transmit the scheduled uplink transmission 628. The difference between the scheduled output power and the calculated maximum transmission output power threshold P_{CMAXf,c,x} or, for CA, P_{CMAX,x}, may be the PHR, which may be reported to the network node 502 (e.g., if some pathloss threshold is satisfied). However, if the scheduled output power is greater than the calculated maximum transmission output power threshold P_{CMAXf,c,x} or, for CA, P_{CMAX,x}, then the UE 504 may reduce the transmission power for the uplink transmission 628 by an amount that reduces the transmission power for the uplink transmission 628 to a level that is less than or equal to the maximum transmission output power threshold P_{CMAXf,c,x} or, for CA, P_{CMAX,x}.

In some aspects, the UE 504 may report the maximum transmission output power threshold 630 P_{CMAXf,c,x} or, for CA, P_{CMAX,x}, to the network node 502. In some aspects, the UE 504 may report the maximum transmission output power threshold 630 P_{CMAXf,c,x} or, for CA, P_{CMAX,x}, to the network node 502 based on a set of criteria, such an amount by which the maximum transmission output power threshold 630 has been reduced, a pathloss value, etc. Such information may be included in a PHR, such as in a MAC CE of a PHR. The PHR may be specific to the one of the antenna panel or the beam having the ID.

In some other aspects, the UE 504 may report the ID-specific P-MPR value(s) 632-P-MPR_{f,c,x} or, for CA, P-MPRₓ—to the network node 502. In some aspects, the UE 504 may report the ID-specific P-MPR value(s) 632-P-MPR_{f,c,x} or, for CA, P-MPRₓ, to the network node 502 based on a set of criteria, such an amount of the ID-specific P-MPR value(s) 632 P-MPR_{f,c,x} or, for CA, P-MPRₓ, a pathloss value, etc. Such information may be included in a PHR, such as in a MAC CE of a PHR. The PHR may be specific to the one of the antenna panel or the beam having the ID.

In some aspects, the network node 502 may receive the reported ID-specific maximum transmission output power threshold 630 (e.g., P_{CMAXf,c,x} or, for CA, P_{CMAX,x}) and/or the reported ID-specific P-MPR value(s) 632 (e.g., P-MPR_{f,c,x} or, for CA, P-MPRₓ). The network node 502 may schedule another transmission by the UE 504 based on the reported ID-specific maximum transmission output power threshold 630 and/or the reported ID-specific P-MPR value(s) 632. For example, the network node 502 may allocate resources to the UE 504 for another uplink transmission and/or the network node 502 may configure an MCS for the other uplink transmission. In some aspects, the network node 502 may allocate an amount of resources (e.g., RBs) for the other transmission by reducing the amount of resources (e.g., RBs) that had been allocated to the scheduled uplink transmission 628, which may result in the UE 504 using a lower transmission output power to transmit the other transmission. In some other aspects, the network node 502 may configure the MCS for the other transmission by lowering the MCS that had been configured for the scheduled uplink transmission 628, which may result in the UE 504 using a lower transmission output power to transmit the other transmission. The network node 502 may transmit information scheduling the other transmission to the UE 504, and the UE 504 may transmit the other transmission based on the received scheduling information.

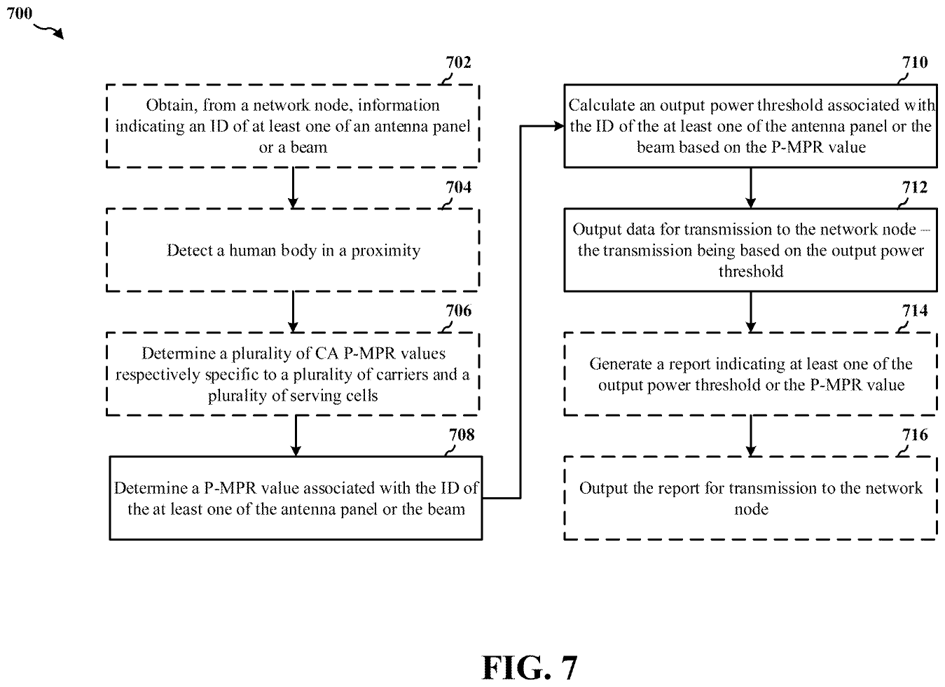

FIG. 7 is a flowchart of a method 700 of wireless communication. The method 700 may be performed by or at a UE (e.g., the UE 104, 350, 404, 504), another wireless communications apparatus (e.g., the apparatus 902), or one or more components thereof. According to various different aspects, one or more of the illustrated blocks may be omitted, transposed, and/or contemporaneously performed.

At 702, the UE may obtain, from a network node, information indicating an ID of at least one of an antenna panel or a beam. For example, the network node may configure the UE with a beam or panel ID x. In some aspects, the UE may receive the information indicating the ID of the at least one of the antenna panel or the beam via RRC signaling from the network node. The UE may receive information indicating the beam or panel ID x, and accordingly, the UE may be able to find P-MPR_{f,c,x} value(s), or P-MPRₓ for CA, for the beam or panel having ID x, as well as P_{CMAXf,c,x}, or P_{CMAX,x} for CA, for the beam or panel having ID x. In some aspects, the information indicating the ID of the at least one of the antenna panel or the beam is obtained based on a capability of the UE. That is, the UE may not be configured with a beam or panel ID if the UE capability message indicates that the UE lacks the capability to perform beam- or panel-specific power management operations. In some other aspects, the ID x of the at least one of the antenna panel or the beam corresponds to at least one of an SSBRI and/or a CRI.

Referring to 702 in the context of FIGS. 5-6, the UE 504 may receive information 624 indicating the antenna panel and/or beam ID(s) from the network node 502.

At 704, the UE may detect a human body in proximity to the UE. For example, the UE may obtain a sensor reading indicative of tissue that is proximate to one or more surfaces of the UE. The UE may determine whether the sensor reading indicates the tissue is within a threshold amount of one or more surfaces of the UE, e.g., such that power management may need to be applied to reduce the risk of RF radio exposure to a person. In some aspects, the UE may further detect which surface(s) of the UE are proximate to the tissue and/or which beams and/or antenna panels are occluded by the tissue. The UE may determine a P-MPR value based on the detection of the human body and based on an electromagnetic power density exposure standard, such as an MPE standard.

In some aspects, the UE may determine at least one of an antenna panel or a beam having an ID x, e.g., to be used for a transmission to the network node. For example, the UE may select at least one of an antenna panel or a beam having an ID x at the network node that is paired with at least one of an antenna panel or a beam at the UE that is not occluded by the detected human body, is not at a surface proximate to the detected human body, etc.

Referring to 704 in the context of FIGS. 5-6, the UE 504 may detect a human body (e.g., the person 494) in proximity to the UE 504. The UE 504 may determine a P-MPR value based on the detection of the human body (e.g., the person 494) and based on an electromagnetic power density exposure standard, such as an MPE standard.

At 706, the UE may determine a plurality of CA P-MPR values that are respectively associated with a plurality of carriers and a plurality of serving cells. For example, the UE may determine a P-MPR/cx value for each of the carriers f₁, . . . , f_{y} of each of the serving cells c₁, . . . , c_{z} that is activated for CA for the UE. For example, for each of the carriers f₁, . . . , f_{y} of each of the serving cells c₁, . . . , c_{z} that is activated for CA for the UE, the UE may determine a value of an electromagnetic power density exposure standard to which the UE adheres when transmitting, and the UE may determine an amount (e.g., in dB) by which a maximum transmission output power should be reduced in order to adhere to the electromagnetic power density exposure standard. The UE may determine each of the CA P-MPR values based on the respective amount by which a maximum transmission output power should be reduced in order to adhere to the electromagnetic power density exposure standard in one of the carrier of one of the serving cells activated for CA.

Referring to 706 in the context of FIGS. 5-6, the UE 504 may determine a plurality of CA P-MPR values that are respectively associated with a plurality of carriers and a plurality of serving cells activated for CA for the UE 504. At least some of the plurality of carriers and the plurality of serving cells may be provided by the network node 502.

At 708, the UE may determine a P-MPR value associated with an ID of at least one of an antenna panel or a beam. That is, the P-MPR value may be specific to an antenna panel or a beam having an ID (e.g., ID x). In some aspects, the UE may determine a P-MPR/cx value specific to the panel or beam having ID x in carrier f of serving cell c by determining a value of an electromagnetic power density exposure standard to which the UE adheres when transmitting and determining an amount (e.g., in dB) by which a maximum transmission output power should be reduced in order to adhere to the electromagnetic power density exposure standard. The UE may determine the P-MPR_{f,c,x} value based on the amount by which a maximum transmission output power should be reduced in order to adhere to the electromagnetic power density exposure standard.

In some other aspects, the UE may synthesize the plurality of CA P-MPR_{f,c,x} values specific to the panel or beam having ID x in the carriers f₁, . . . , f_{y} of serving cells c₁, . . . , c_{z} activated for CA for the UE. For example, the UE may aggregate the CA P-MPR values, and the UE may determine a P-MPRₓ value that is specific to the antenna panel or beam having ID x and is applicable in the carriers f₁, . . . , f_{y} of serving cells c₁, . . . , C-activated for CA for the UE. For example, the UE may use a sum function or average function to find a value (e.g., in dB) by which the maximum transmission output power is to be reduced in all of the carriers f₁, . . . , f_{y} of serving cells c₁, . . . , c_{z} activated for CA for the UE.

Referring to 708 in the context of FIGS. 5-6, the UE 504 may determine a P-MPR value 632 associated with an ID of at least one of the node antenna panels 512a-512b or at least one of the node beams 522. In some aspects, the UE 504 may determine a P-MPR_{f,c,x} value specific to the panel or beam having ID x in carrier f of serving cell c. In some other aspects, the UE 504 may determine a P-MPRₓ value specific to the panel or beam having ID x in the carriers f₁, . . . , f_{y} of serving cells c₁, . . . , c_{z} activated for CA for the UE 504.

At 710, the UE may calculate an output power threshold associated with the ID of the at least one of the antenna panel or the beam based on the P-MPR value. The output power threshold may be a maximum output power threshold that is not exceeded by a transmission power of a transmission. For example, the UE may calculate an output power threshold P_{CMAXf,c,x} specific to an antenna panel or a beam having ID x in carrier f of serving cell c, and if a person is proximate to the UE, the UE may reduce the output power threshold P_{CMAXf,c,x} by the P-MPR_{f,c,x} value specific to the panel or beam having ID x in carrier f of serving cell c. In some other examples, the UE may calculate an output power threshold P_{CMAX,x} specific to an antenna panel or a beam having ID x in the carriers f₁, . . . , f_{y} of serving cells c₁, . . . , c_{z} activated for CA for the UE, and if a person is proximate to the UE, the UE may reduce the output power threshold P_{CMAX,x} by the P-MPR_{,x} value specific to the panel or beam having ID x in the carriers f₁, . . . , f_{y} of serving cells c₁, . . . , c_{z} activated for CA for the UE.

Referring to 710 in the context of FIGS. 5-6, the UE 504 may calculate an output power threshold 630 associated with the ID of at least one of the antenna panels 512a-512b or at least one of the beams 522 based on a P-MPR value 632. For example, the UE 504 may calculate an output power threshold P_{CMAXf,c,x} specific to an antenna panel or a beam having ID x in carrier f of serving cell c, and if a person is proximate to the UE 504, the UE 504 may reduce the output power threshold P_{CMAXf,c,x} by the P-MPR_{f,c,x} value specific to the panel or beam having ID x in carrier f of serving cell c. In some other examples, the UE 504 may calculate an output power threshold P_{CMAX,x} specific to an antenna panel or a beam having ID x in the carriers f₁, . . . , f_{y} of serving cells c₁, . . . , c_{z} activated for CA for the UE 504, and if a person is proximate to the UE 504, the UE 504 may reduce the output power threshold P_{CMAX,x} by the P-MPRₓ value specific to the panel or beam having ID x in the carriers f₁, . . . , f_{y} of serving cells c₁, . . . , c_{z} activated for CA for the UE 504.

At 712, the UE may output data for transmission to the network node, and the transmission may be based on the output power threshold. For example, an interface may modulate the data and may provide the modulated data to circuitry (e.g., an RF front end, etc.) for transmission. The UE may transmit data on an uplink data channel (e.g., a PUSCH) either at a transmission power level that is calculated based on at least the resources allocated to the data transmission and the MCS configured for the data transmission, if the transmission power level does not exceed the output power threshold, or at the output power level threshold, if the calculated transmission power exceeds the output power threshold.

Referring to 712 in the context of FIGS. 5-6, the UE 504 may output data for the scheduled uplink transmission 628 to the network node 502. The UE 504 may transmit the transmission 628 based on the ID-specific output power threshold 630.

At 714, the UE may generate a report indicating at least one of the output power threshold or the P-MPR value. For example, the UE may generate a PHR or other report associated with the ID of the at least one of the antenna panel or the beam, and the UE may prepend a header thereon. The header may include one or more MAC CEs, and the UE may populate the one or more MAC CEs with at least one of the output power threshold specific to the antenna panel or beam having the ID x or the P-MPR value(s) specific to the antenna panel or beam having the ID x.

Referring to 714 in the context of FIGS. 5-6, the UE 504 may generate a report indicating at least one of the ID-specific output power threshold 630 or the ID-specific P-MPR value(s) 632. The UE may populate one or more MAC CEs of the report with at least one of the ID-specific output power threshold 630 or the ID-specific P-MPR value(s) 632.

At 716, the UE may output the report for transmission to the network node. For example, the UE may transmit the report to the network node when some criteria has been satisfied, such as when the output power threshold satisfies one threshold and/or the P-MPR value satisfies another threshold.

Referring to 716 in the context of FIGS. 5-6, the UE 504 may output the report indicating at least one of the ID-specific output power threshold 630 or the ID-specific P-MPR value(s) 632 for transmission to the network node 502.

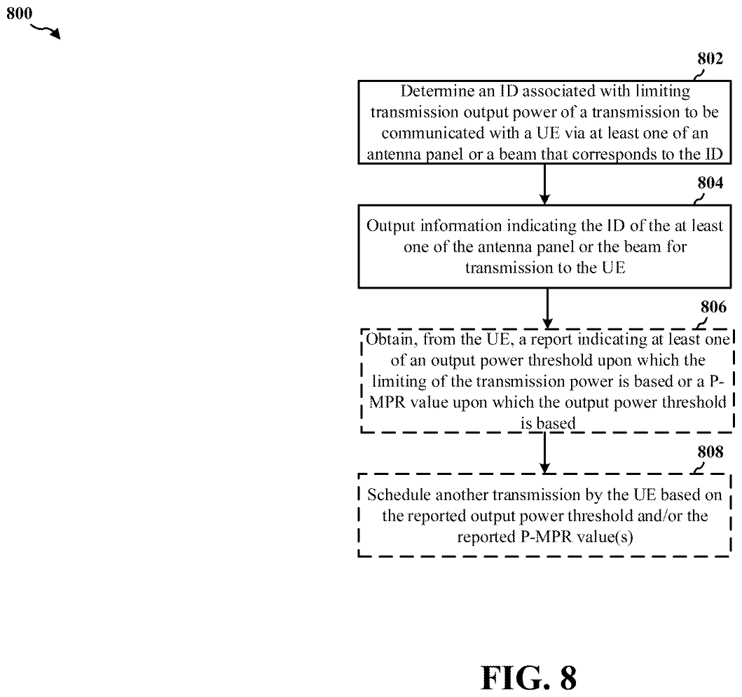

FIG. 8 is a flowchart of a method 800 of wireless communication. The method 800 may be performed by or at a network node (e.g., the network node 102/180, 310, 502), another wireless communications apparatus (e.g., the apparatus 1002), or one or more components thereof. According to various different aspects, one or more of the illustrated blocks may be omitted, transposed, and/or contemporaneously performed.

At 802, the network node may determine an ID associated with limiting transmission output power of a transmission to be communicated with a UE via at least one of an antenna panel or a beam that corresponds to the ID. For example, the network node may determine a direction or sector in which the UE is positioned relative to the network node. The network node may identify the antenna panels or beams that are capable of transmitting signals to the direction or sector of the UE, and the network node may determine the IDs of the antenna panels or beams, e.g., to communicate with the UE via the antenna panels or beams. In some aspects, the ID of the at least one of the antenna panel or the beam may correspond to at least one of an SSBRI or a CRI.

Referring to 802 in the context of FIGS. 5-6, the network node 502 may determine an ID associated with limiting transmission output power of a transmission to be communicated with the UE 504 via at least one of the node antenna panels 512a-512b or node beams 522 that corresponds to the ID. The UE 504 may be configured to apply an output power threshold 630 associated with the ID of the one of the node antenna panels 512a-512b and/or node beams 522 based on a P-MPR value 632 associated with the ID of the one of the node antenna panels 512a-512b and/or node beams 522. For example, the network node 502 may determine an ID x of the one of the node antenna panels 512a-512b and/or node beams 522, and the UE 504 may be configured to calculate an output power threshold 630 P_{CMAXf,c,x} specific to one of the node antenna panels 512a-512b and/or node beams 522 having ID x in carrier f of serving cell c, and if a person is proximate to the UE 504, the UE 504 may reduce the output power threshold P_{CMAXf,c,x} by the P-MPR_{f,c,x} value specific to the panel or beam having ID x in carrier f of serving cell c. In some other examples, the network node 502 may determine an ID x of the one of the node antenna panels 512a-512b and/or node beams 522, and the UE 504 may calculate an output power threshold P_{CMAX,x} specific to the one of the node antenna panels 512a-512b and/or node beams 522 having ID x in the carriers f₁, . . . , f_{y} of serving cells c₁, . . . , c_{z} activated for CA for the UE 504, and if a person is proximate to the UE 504, the UE 504 may reduce the output power threshold 630 P_{CMAX,x} by the P-MPRₓ value 632 specific to the panel or beam having ID x in the carriers f₁, . . . , f_{y} of serving cells c₁, . . . , c_{z} activated for CA for the UE 504.

At 804, the network node may output information indicating the ID of the at least one of the antenna panel or the beam for transmission to the UE. In some examples, the information indicating the ID of the at least one of the antenna panel or the beam is output for transmission to the UE based on a capability of the UE. In some other examples, the information indicating the ID of the at least one of the antenna panel or the beam is output for transmission via RRC signaling.

Referring to 804 in the context of FIGS. 5-6, the network node 502 may output information 624 indicating the ID of the at least one of the node antenna panels 512a-512b or node beams 522 for transmission to the UE 504.

At 806, the network node may obtain, from the UE, a report indicating at least one of an output power threshold upon which the limiting of the transmission power is based or a power reduction value (e.g., P-MPR value) upon which the output power threshold is based. In some aspects, the report includes a PHR associated with the ID of the at least one of the antenna panel or the beam. In some other aspects, the ID of the at least one of the antenna panel or the beam associated with the at least one of the output power threshold or the power reduction value (e.g., P-MPR value) indicated in the report is selected by the UE. For example, the network node may demodulate signals and the network node may recover the report based on the demodulated signals.

Referring to 806 in the context of FIGS. 5-6, the network node 502 may obtain, from the UE 504, a report indicating at least one of the ID-specific output power threshold 630 or the ID-specific P-MPR value 632.

At 808, the network node may schedule another transmission by the UE based on the reported ID-specific maximum transmission output power threshold and/or the reported ID-specific P-MPR value(s). For example, the network node may allocate resources to the UE for another uplink transmission and/or the network node may configure an MCS for the other uplink transmission. In some aspects, the network node may allocate an amount of resources (e.g., RBs) for the other transmission by reducing the amount of resources (e.g., RBs) that had been allocated to the scheduled uplink transmission, which may result in the UE using a lower transmission output power to transmit the other transmission. In some other aspects, the network node may configure the MCS for the other transmission by lowering the MCS that had been configured for the scheduled uplink transmission, which may result in the UE using a lower transmission output power to transmit the other transmission. The network node may transmit information scheduling the other transmission to the UE.

Referring to 808 in the context of FIGS. 5-6, the network node 502 may schedule another transmission by the UE 504 based on the reported ID-specific maximum transmission output power threshold 630 and/or the reported ID-specific P-MPR value(s) 632. For example, the network node 502 may allocate resources to the UE 504 for another uplink transmission and/or the network node 502 may configure an MCS for the other uplink transmission. In some aspects, the network node 502 may allocate an amount of resources (e.g., RBs) for the other transmission by reducing the amount of resources (e.g., RBs) that had been allocated to the scheduled uplink transmission 628, which may result in the UE 504 using a lower transmission output power to transmit the other transmission. In some other aspects, the network node 502 may configure the MCS for the other transmission by lowering the MCS that had been configured for the scheduled uplink transmission 628, which may result in the UE 504 using a lower transmission output power to transmit the other transmission. The network node 502 may transmit information scheduling the other transmission to the UE 504.

### Example Wireless Communications Devices

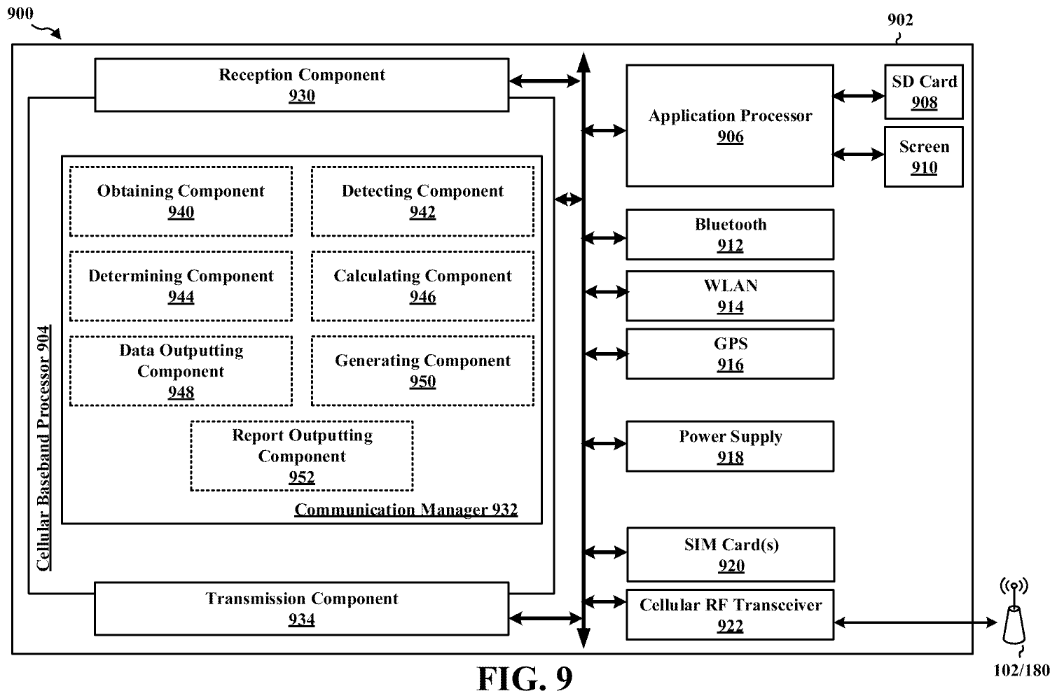

FIG. 9 is a diagram illustrating an example of a hardware implementation 900 for an apparatus 902. The apparatus 902 may be a UE or similar device, or the apparatus 902 may be a component of a UE or similar device. The apparatus 902 may include a cellular baseband processor 904 (also referred to as a modem) and/or a cellular RF transceiver 922, which may be coupled together and/or integrated into the same package, component, circuit, chip, and/or other circuitry.

In some aspects, the apparatus 902 may accept or may include one or more subscriber identity modules (SIM) cards 920, which may include one or more integrated circuits, chips, or similar circuitry, and which may be removable or embedded. The one or more SIM cards 920 may carry identification and/or authentication information, such as an international mobile subscriber identity (IMSI) and/or IMSI-related key(s). Further, the apparatus 902 may include one or more of an application processor 906 coupled to a secure digital (SD) card 908 and a screen 910, a Bluetooth module 912, a wireless local area network (WLAN) module 914, a Global Positioning System (GPS) module 916, and/or a power supply 918.

The cellular baseband processor 904 communicates through the cellular RF transceiver 922 with the UE 104 and/or network node 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904.

In the context of FIG. 3, the cellular baseband processor 904 may be a component of the UE 350 and may include the memory 360 and/or at least one of the TX processor 368, the RX processor 356, and/or the controller/processor 359. In one configuration, the apparatus 902 may be a modem chip and/or may be implemented as the baseband processor 904, while in another configuration, the apparatus 902 may be the entire UE (e.g., the UE 350 of FIG. 3) and may include some or all of the abovementioned components, circuits, chips, and/or other circuitry illustrated in the context of the apparatus 902. In one configuration, the cellular RF transceiver 922 may be implemented as at least one of the transmitter 354TX and/or the receiver 354RX.

The reception component 930 may be configured to receive signaling on a wireless channel, such as signaling from a network node 102/180 or UE 104. The transmission component 934 may be configured to transmit signaling on a wireless channel, such as signaling to a network node 102/180 or UE 104. The communication manager 932 may coordinate or manage some or all wireless communications by the apparatus 902, including across the reception component 930 and the transmission component 934.

The reception component 930 may function as an interface for signaling into the cellular baseband processor 904 or the communication manager 932. For example, the reception component 930 may be an interface of a processor or a processing system and may provide some or all data or control information included in received signaling to the communication manager 932. The transmission component 934 may function as an interface for signaling out of the cellular baseband processor 904 or the communication manager 932. For example, the transmission component 934 may be an interface of a processor or a processing system and may provide some or all data or control information to be included in signaling to the cellular RF transceiver 922 from the communication manager 932. Further, the communication manager 932 may generate and provide some or all of the data or control information to be included in transmitted signaling to the transmission component 934.

The reception component 930 may provide some or all data and/or control information included in received signaling to the communication manager 932, and the communication manager 932 may generate and provide some or all of the data and/or control information to be included in transmitted signaling to the transmission component 934. The communication manager 932 may include the various illustrated components, including one or more components configured to process received data and/or control information, and/or one or more components configured to generate data and/or control information for transmission.

The communication manager 932 may include an obtaining component 940, a detecting component 942, a determining component 944, a calculating component 946, a data outputting component 948, a generating component 950, and a report outputting component 952.

The obtaining component 940 may be configured to obtain, from the network node 102/180, information indicating an ID of at least one of an antenna panel or a beam, e.g., as described in connection with 702 of FIG. 7. For example, the network node 102/180 may configure the apparatus 902 with a beam or panel ID x. In some aspects, the apparatus 902 may receive the information indicating the ID of the at least one of the antenna panel or the beam via RRC signaling from the network node 102/180. The obtaining component 940 may obtain information indicating the beam or panel ID x, and accordingly, the determining component 944 may be able to find P-MPR_{f,c,x} value(s), or P-MPRₓ for CA, for the beam or panel having ID x, as well as P_{CMAXf,c,x}, or P_{CMAX,x} for CA, for the beam or panel having ID x. In some aspects, the information indicating the ID of the at least one of the antenna panel or the beam is obtained based on a capability of the apparatus 902. That is, the apparatus 902 may not be configured with a beam or panel ID if the apparatus 902 lacks the capability to perform beam- or panel-specific power management operations. In some other aspects, the ID x of the at least one of the antenna panel or the beam corresponds to at least one of an SSBRI and/or a CRI.

The detecting component 942 may be configured to detect a human body in proximity to the apparatus 902, e.g., as described in connection with 704 of FIG. 7. For example, the detecting component 942 may obtain a sensor reading indicative of tissue that is proximate to one or more surfaces of the apparatus 902. The detecting component 942 may determine whether the sensor reading indicates the tissue is within a threshold amount of one or more surfaces of the apparatus 902, e.g., such that power management may need to be applied to reduce the risk of RF radio exposure to a person. In some aspects, the detecting component 942 may further detect which surface(s) of the apparatus 902 are proximate to the tissue and/or which beams and/or antenna panels are occluded by the tissue. The determining component 944 may determine a P-MPR value based on the detection of the human body and based on an electromagnetic power density exposure standard, such as an MPE standard.

In some aspects, the determining component 944 may determine at least one of an antenna panel or a beam having an ID x, e.g., to be used for a transmission to the network node 102/180. For example, the determining component 944 may select at least one of an antenna panel or a beam having an ID x at the network node 102/180 that is paired with at least one of an antenna panel or a beam at the apparatus 902 that is not occluded by the detected human body, is not at a surface proximate to the detected human body, etc.

The determining component 944 may be configured to determine a plurality of CA P-MPR values that are respectively associated with a plurality of carriers and a plurality of serving cells, e.g., as described in connection with 706 of FIG. 7. For example, the determining component 944 may determine a P-MPR_{f,c,x} value for each of the carriers f₁, . . . , f_{y} of each of the serving cells c₁, . . . , c_{z} that is activated for CA for the apparatus 902. For example, for each of the carriers f₁, . . . , f_{y} of each of the serving cells c₁, . . . , c_{z} that is activated for CA for the apparatus 902, the determining component 944 may determine a value of an electromagnetic power density exposure standard to which the apparatus 902 adheres when transmitting, and the determining component 944 may determine an amount (e.g., in dB) by which a maximum transmission output power should be reduced in order to adhere to the electromagnetic power density exposure standard. The determining component 944 may determine each of the CA P-MPR values based on the respective amount by which a maximum transmission output power should be reduced in order to adhere to the electromagnetic power density exposure standard in one of the carrier of one of the serving cells activated for CA.

In some aspects, the determining component 944 may be further configured to determine a P-MPR value associated with an ID of at least one of an antenna panel or a beam, e.g., as described in connection with 708 of FIG. 7. That is, the P-MPR value may be specific to an antenna panel or a beam having an ID (e.g., ID x). In some aspects, the determining component 944 may determine a P-MPR_{f,c,x} value specific to the panel or beam having ID x in carrier f of serving cell c by determining a value of an electromagnetic power density exposure standard to which the apparatus 902 adheres when transmitting and determining an amount (e.g., in dB) by which a maximum transmission output power should be reduced in order to adhere to the electromagnetic power density exposure standard. The determining component 944 may determine the P-MPR_{f,c,x} value based on the amount by which a maximum transmission output power should be reduced in order to adhere to the electromagnetic power density exposure standard.

In some other aspects, the determining component 944 may synthesize the plurality of CA P-MPR_{f,c,x} values specific to the panel or beam having ID x in the carriers f₁, . . . , f_{y} of serving cells c₁, . . . , c_{z} activated for CA for the apparatus 902. For example, the determining component 944 may aggregate the CA P-MPR values, and the determining component 944 may determine a P-MPRₓ value that is specific to the antenna panel or beam having ID x and is applicable in the carriers f₁, . . . , f_{y} of serving cells c₁, . . . , c_{z} activated for CA for the apparatus 902. For example, the determining component 944 may use a sum function or average function to find a value (e.g., in dB) by which the maximum transmission output power is to be reduced in all of the carriers f₁, . . . , f, of serving cells c₁, . . . , c_{z} activated for CA for the apparatus 902.

The calculating component 946 may be configured to calculate an output power threshold associated with the ID of the at least one of the antenna panel or the beam based on the P-MPR value, e.g., as described in connection with 710 of FIG. 7. The output power threshold may be a maximum output power threshold that is not exceeded by a transmission power of a transmission. For example, the calculating component 946 may calculate an output power threshold P_{CMAXf,c,x} specific to an antenna panel or a beam having ID x in carrier f of serving cell c, and if a person is proximate to the apparatus 902, the calculating component 946 may reduce the output power threshold P_{CMAXf,c,x} by the P-MPR_{f,c,x} value specific to the panel or beam having ID x in carrier f of serving cell c. In some other examples, the calculating component 946 may calculate an output power threshold P_{CMAX,x} specific to an antenna panel or a beam having ID x in the carriers f₁, . . . f_{y} of serving cells c₁, . . . , c_{z} activated for CA for the apparatus 902, and if a person is proximate to the apparatus 902, the calculating component 946 may reduce the output power threshold P_{CMAX,x} by the P-MPRₓ value specific to the panel or beam having ID x in the carriers f₁, . . . , f_{y} of serving cells c₁, . . . , c_{z} activated for CA for the apparatus 902.

The data outputting component 948 may be configured to output data for transmission to the network node 102/180, and the transmission may be based on the output power threshold, e.g., as described in connection with 712 of FIG. 7. For example, an interface may modulate the data and may provide the modulated data to circuitry (e.g., an RF front end, etc.) for transmission. The transmission component 934 may transmit data on an uplink data channel (e.g., a PUSCH) either at a transmission power level that is calculated based on at least the resources allocated to the data transmission and the MCS configured for the data transmission, if the transmission power level does not exceed the output power threshold, or at the output power level threshold, if the calculated transmission power exceeds the output power threshold.

The generating component 950 may be configured to generate a report indicating at least one of the output power threshold or the P-MPR value, e.g., as described in connection with 714 of FIG. 7. For example, the generating component 950 may generate a PHR or other report associated with the ID of the at least one of the antenna panel or the beam, and the generating component 950 may prepend a header thereon. The header may include one or more MAC CEs, and the generating component 950 may populate the one or more MAC CEs with at least one of the output power threshold specific to the antenna panel or beam having the ID x or the P-MPR value(s) specific to the antenna panel or beam having the ID x.

The report outputting component 952 may be configured to output the report for transmission to the network node 102/180, e.g., as described in connection with 716 of FIG. 7. For example, the transmission component 934 may transmit the report to the network node 102/180 when some criteria has been satisfied, such as when the output power threshold satisfies one threshold and/or the P-MPR value satisfies another threshold.

The apparatus 902 may include additional components that perform some or all of the blocks, operations, signaling, etc. of the algorithms in the aforementioned call flow diagrams and/or flowcharts of FIGS. 6-7. As such, some or all of the blocks, operations, signaling, etc. in the aforementioned call flow diagrams and/or flowcharts of FIGS. 6-7 may be performed by one or more components and the apparatus 902 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes means for determining a P-MPR value associated with an ID of at least one of an antenna panel or a beam; means for calculating an output power threshold associated with the ID of the at least one of the antenna panel or the beam based on the P-MPR value; and means for outputting data for transmission to a network node, the transmission being based on the output power threshold.

In one configuration, the output power threshold includes a maximum output power threshold that is not exceeded by a transmission power of the transmission.

In one configuration, the apparatus 902, and in particular the cellular baseband processor 904, may further include means for generating a report indicating at least one of the output power threshold or the P-MPR value; and means for outputting the report for transmission to the network node.

In one configuration, the apparatus 902, and in particular the cellular baseband processor 904, may further include means for selecting the at least one of the antenna panel or the beam having the ID.

In one configuration, the report indicating at least one of the output power threshold or the P-MPR value includes a PHR associated with the ID of the at least one of the antenna panel or the beam.

In one configuration, each of the P-MPR value and the output power threshold is specific to the at least one of the antenna panel or the beam having the ID.

In one configuration, the apparatus 902, and in particular the cellular baseband processor 904, may further include means for detecting a human body in proximity to the apparatus 902, and the P-MPR value is determined based on the detecting and based on an electromagnetic power density exposure standard.

In one configuration, each of the P-MPR value and the output power threshold is further associated with a carrier and a serving cell.

In one configuration, the apparatus 902, and in particular the cellular baseband processor 904, may further include means for determining a plurality of CA P-MPR values that are respectively associated with a plurality of carriers and a plurality of serving cells, and the P-MPR value is determined based on the plurality of CA P-MPR values.

In one configuration, the apparatus 902, and in particular the cellular baseband processor 904, may further include means for obtaining, from the network node, information indicating the ID of the at least one of the antenna panel or the beam.

In one configuration, the information indicating the ID of the at least one of the antenna panel or the beam is obtained based on a UE capability associated with the apparatus 902.

In one configuration, the information indicating the ID of the at least one of the antenna panel or the beam is obtained from the network node via RRC signaling.

In one configuration, the ID of the at least one of the antenna panel or the beam corresponds to at least one of a SSBRI or a CRI.

The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

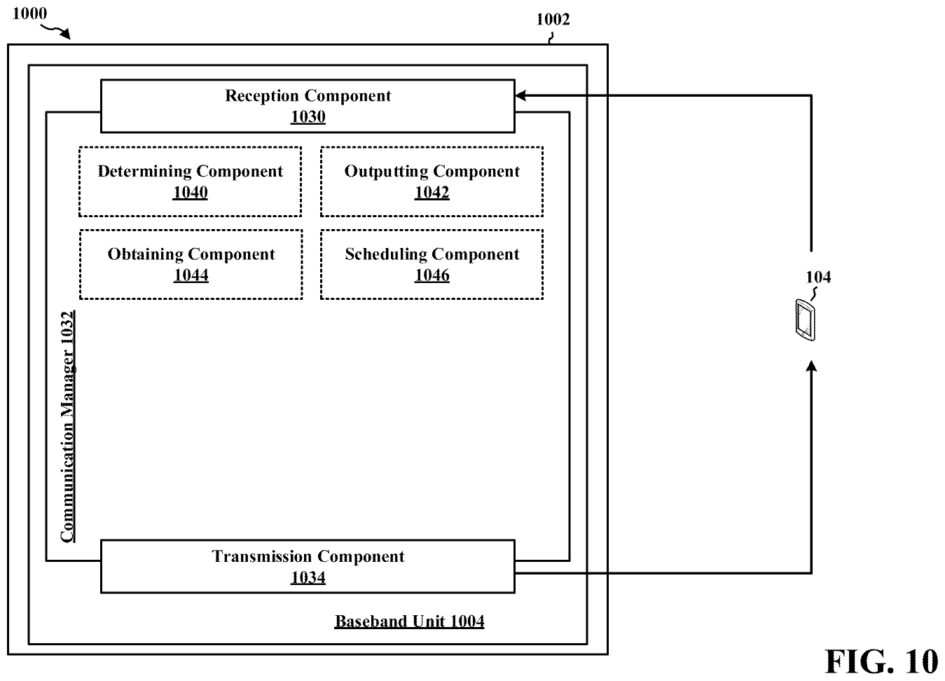

FIG. 10 is a diagram 1000 illustrating an example of a hardware implementation for an apparatus 1002. The apparatus 1002 may be a network node or similar device or system, or the apparatus 1002 may be a component of a network node or similar device or system. The apparatus 1002 may include a baseband unit 1004. The baseband unit 1004 may communicate through a cellular RF transceiver. For example, the baseband unit 1004 may communicate through a cellular RF transceiver with a UE 104, such as for downlink and/or uplink communication, and/or with a network node 102/180, such as for IAB.

The baseband unit 1004 may include a computer-readable medium/memory, which may be non-transitory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the network node 310 and may include the memory 376 and/or at least one of the TX processor 316, the RX processor 370, and the controller/processor 375.

The reception component 1030 may be configured to receive signaling on a wireless channel, such as signaling from a UE 104 or network node 102/180. The transmission component 1034 may be configured to transmit signaling on a wireless channel, such as signaling to a UE 104 or network node 102/180. The communication manager 1032 may coordinate or manage some or all wireless communications by the apparatus 1002, including across the reception component 1030 and the transmission component 1034.

The reception component 1030 may function as an interface for signaling into the baseband unit 1004 or the communication manager 1032. For example, the reception component 1030 may be an interface of a processor or a processing system and may provide some or all data or control information included in received signaling to the communication manager 1032. The transmission component 1034 may function as an interface for signaling out of the baseband unit 1004 or the communication manager 1032. For example, the transmission component 1034 may be an interface of a processor or a processing system and may provide some or all data or control information to be included in signaling from the communication manager 1032.

The reception component 1030 may provide some or all data and/or control information included in received signaling to the communication manager 1032, and the communication manager 1032 may generate and provide some or all of the data and/or control information to be included in transmitted signaling to the transmission component 1034. The communication manager 1032 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1032 may include a determining component 1040, an outputting component 1042, an obtaining component 1044, and a scheduling component 1046.

The determining component 1040 may be configured to determine an ID associated with limiting transmission output power of a transmission to be communicated with a UE 104 via at least one of an antenna panel or a beam that corresponds to the ID, e.g., as described in connection with 802 of FIG. 8. For example, the determining component 1040 may determine a direction or sector in which the UE 104 is positioned relative to the apparatus 1002. The determining component 1040 may identify the antenna panels or beams that are capable of transmitting signals to the direction or sector of the UE 104, and the determining component 1040 may determine the IDs of the antenna panels or beams, e.g., to communicate with the UE 104 via the antenna panels or beams. In some aspects, the ID of the at least one of the antenna panel or the beam may correspond to at least one of an SSBRI or a CRI.

The UE 104 may be configured to apply an output power threshold associated with the ID of the one of the antenna panels and/or beams based on a P-MPR value associated with the ID of the one of the antenna panels and/or beams. For example, the determining component 1040 may determine an ID x of the one of the antenna panels and/or beams, and the UE 104 may be configured to calculate an output power threshold P_{CMAXf,c,x} specific to one of the antenna panels and/or beams having ID x in carrier f of serving cell c, and if a person is proximate to the UE 104, the UE 104 may reduce the output power threshold P_{CMAXf,c,x} by the P-MPR_{f,c,x} value specific to the panel or beam having ID x in carrier f of serving cell c. In some other examples, the determining component 1040 may determine an ID x of the one of the antenna panels and/or beams, and the UE 104 may calculate an output power threshold P_{CMAX,x} specific to the one of the antenna panels and/or beams having ID x in the carriers f₁, . . . , f_{y} of serving cells c₁, . . . , c_{z} activated for CA for the UE 104, and if a person is proximate to the UE 104, the UE 104 may reduce the output power threshold P_{CMAX,x} by the P-MPRₓ value specific to the panel or beam having ID x in the carriers f₁, . . . , f_{y} of serving cells c₁, . . . , c_{z} activated for CA for the UE 104.

The outputting component 1042 may output information indicating the ID of the at least one of the antenna panel or the beam for transmission to the UE 104, e.g., as described in connection with 804 of FIG. 8. In some examples, the information indicating the ID of the at least one of the antenna panel or the beam is output for transmission to the UE 104 based on a capability of the UE 104. In some other examples, the information indicating the ID of the at least one of the antenna panel or the beam is output for transmission via RRC signaling.

The obtaining component 1044 may obtain, from the UE 104, a report indicating at least one of an output power threshold upon which the limiting of the transmission power is based or a power reduction value upon which the output power threshold is based, e.g., as described in connection with 806 of FIG. 8. In some aspects, the report includes a PHR associated with the ID of the at least one of the antenna panel or the beam. In some other aspects, the ID of the at least one of the antenna panel or the beam associated with the at least one of the output power threshold or the power reduction value (e.g., P-MPR value) indicated in the report is selected by the UE 104. The scheduling component 1046 may be configured schedule another transmission by the UE 104 based on the reported ID-specific maximum transmission output power threshold and/or the reported ID-specific P-MPR value(s), e.g., as described in connection with 808 of FIG. 8. For example, the scheduling component 1046 may allocate resources to the UE 104 for another uplink transmission and/or the scheduling component 1046 may configure an MCS for the other uplink transmission. In some aspects, the scheduling component 1046 may allocate an amount of resources (e.g., RBs) for the other transmission by reducing the amount of resources (e.g., RBs) that had been allocated to the scheduled uplink transmission, which may result in the UE 104 using a lower transmission output power to transmit the other transmission. In some other aspects, the scheduling component 1046 may configure the MCS for the other transmission by lowering the MCS that had been configured for the scheduled uplink transmission, which may result in the UE 104 using a lower transmission output power to transmit the other transmission. The transmission component 1034 may transmit information scheduling the other transmission to the UE 104.

The apparatus 1002 may include additional components that perform some or all of the blocks, operations, signaling, etc. of the algorithms in the aforementioned call flow diagram and flowchart of FIGS. 6 and 8. As such, some or all of the blocks, operations, signaling, etc. in the aforementioned call flow diagram and/or flowchart of FIGS. 6 and 8 may be performed by a component and the apparatus 1002 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for determining an ID associated with limiting transmission output power of a transmission to be communicated with a UE via at least one of an antenna panel or a beam that corresponds to the ID; and means for outputting information indicating the ID of the at least one of the antenna panel or the beam for transmission to the UE.

In one configuration, the information indicating the ID of the at least one of the antenna panel or the beam is output for transmission to the UE based on a capability of the UE.

In one configuration, the information indicating the ID of the at least one of the antenna panel or the beam is output for transmission via RRC signaling.

In one configuration, the apparatus 1002, and in particular the baseband unit 1004, may further include means for obtaining, from the UE, a report indicating at least one of an output power threshold upon which the limiting of the transmission power is based or a power reduction value upon which the output power threshold is based; and means for scheduling the UE based on the at least one of the output power threshold or the power reduction value.

In one configuration, the report includes a PHR associated with the ID of the at least one of the antenna panel or the beam.

In one configuration, the ID of the at least one of the antenna panel or the beam corresponds to at least one of a SSBRI or a CRI.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### Example Aspects

Implementation examples are described in the following numbered aspects:

Aspect 1: A method of wireless communications at a UE, comprising: determining a power reduction value associated with an ID of at least one of an antenna panel or a beam; calculating an output power threshold associated with the ID of the at least one of the antenna panel or the beam based on the power reduction value; and outputting data for transmission to a network node, the transmission being based on the output power threshold.

Aspect 2: The method of Aspect 1, wherein the output power threshold comprises a maximum output power threshold that is not exceeded by a transmission power of the transmission, and the power reduction value comprises a P-MPR value that is associated with reduction of the maximum output power threshold.

Aspect 3: The method of any of Aspects 1-2, further comprising generating a report indicating at least one of the output power threshold or the power reduction value; and outputting the report for transmission to the network node.

Aspect 4: The method of Aspect 3, wherein the report indicating at least one of the output power threshold or the power reduction value includes a PHR associated with the ID of the at least one of the antenna panel or the beam.

Aspect 5: The method of any of Aspects 1-4, further comprising selecting the at least one of the antenna panel or the beam having the ID.

Aspect 6: The method of any of Aspects 1-5, wherein each of the power reduction value and the output power threshold is specific to the at least one of the antenna panel or the beam.

Aspect 7: The method of any of Aspects 1-6, further comprising detecting a human body in a proximity, wherein the power reduction value is determined after the detecting and based on an electromagnetic power density exposure standard.

Aspect 8: The method of any of Aspects 1-7, wherein each of the power reduction value and the output power threshold is further associated with a carrier and a serving cell.

Aspect 9: The method of any of Aspects 1-7, further comprising determining a plurality of CA power reduction values that are respectively associated with a plurality of carriers and a plurality of serving cells, wherein the power reduction value is determined based on the plurality of CA power reduction values.

Aspect 10: The method of any of Aspects 1-9, further comprising obtaining, from the network node, information indicating the ID of the at least one of the antenna panel or the beam.

Aspect 11: The method of Aspect 10, wherein the information indicating the ID of the at least one of the antenna panel or the beam is obtained based on a UE capability.

Aspect 12: The method of any of Aspects 10-11, wherein the information indicating the ID of the at least one of the antenna panel or the beam is obtained via RRC signaling.

Aspect 13: The method of any of Aspects 1-12, wherein the ID of the at least one of the antenna panel or the beam corresponds to at least one of a SSBRI or a CRI.

Aspect 14: A method of wireless communications at a network node, comprising: determining an ID associated with limiting transmission output power of a transmission to be communicated with a UE via at least one of an antenna panel or a beam that corresponds to the ID; and outputting information indicating the ID of the at least one of the antenna panel or the beam for transmission to the UE.

Aspect 15: The method of Aspect 14, wherein the information indicating the ID of the at least one of the antenna panel or the beam is output for transmission to the UE via RRC signaling based on a capability of the UE.

Aspect 16: The method of any of Aspects 14-15, further comprising obtaining, from the UE, a report indicating at least one of an output power threshold upon which the limiting of the transmission power is based or a power reduction value upon which the output power threshold is based; and scheduling the UE based on the at least one of the output power threshold or the power reduction value.

Aspect 17: The method of Aspect 16, wherein the report comprises a PHR associated with the ID of the at least one of the antenna panel or the beam.

Aspect 18: The method of any of Aspects 14-17, wherein the ID of the at least one of the antenna panel or the beam corresponds to at least one of a SSBRI or a CRI.

Aspect 19: An apparatus for wireless communications, comprising: a memory comprising instructions; and one or more processors configured to execute the instructions to cause the apparatus to perform a method in accordance with any one of Aspects 1-18.

Aspect 20: A UE, comprising: at least one transceiver; a memory comprising instructions; and one or more processors configured to execute the instructions to cause the UE to perform a method in accordance with any one of Aspects 1-14, wherein the at least one transceiver is configured to transmit based on the output power threshold the data to the network node.

Aspect 21: A network node, comprising: at least one transceiver; a memory comprising instructions; and one or more processors configured to execute the instructions to cause the network node to perform a method in accordance with any one of Aspects 14-18, wherein the at least one transceiver is configured to transmit the information indicating the ID of the at least one of the antenna panel or the beam to the UE.

Aspect 22: An apparatus for wireless communications, comprising means for performing a method in accordance with any one of Aspects 1-18.

Aspect 23: A non-transitory, computer-readable medium comprising instructions that, when executed by an apparatus, cause the apparatus to perform a method in accordance with any one of Aspects 1-18.

### Additional Considerations

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communications, comprising:
a processing system configured to:
determine a power reduction value associated with an identifier (ID) of at least one of an antenna panel or a beam, and
calculate an output power threshold associated with the ID of the at least one of the antenna panel or the beam based on the power reduction value; and
a first interface configured to output data for transmission to a network node, the transmission being based on the output power threshold.

2. The apparatus of claim 1, wherein the output power threshold comprises a maximum output power threshold that is not exceeded by a transmission power of the transmission, and the power reduction value comprises a Power Management Maximum Power Reduction (P-MPR) value that is associated with reduction of the maximum output power threshold.

3. The apparatus of claim 1, wherein the processing system is further configured to generate a report indicating at least one of the output power threshold or the power reduction value, and wherein the first interface is further configured to output the report for transmission to the network node.

4. The apparatus of claim 1, wherein the processing system is further configured to select the at least one of the antenna panel or the beam having the ID.

5. The apparatus of claim 3, wherein the report indicating at least one of the output power threshold or the power reduction value includes a power headroom report (PHR) associated with the ID of the at least one of the antenna panel or the beam.

6. The apparatus of claim 1, wherein each of the power reduction value and the output power threshold is specific to the at least one of the antenna panel or the beam.

7. The apparatus of claim 1, wherein the processing system is further configured to:
detect a human body in proximity to the apparatus, wherein the power reduction value is determined after the detection and based on an electromagnetic power density exposure standard.

8. The apparatus of claim 1, wherein each of the power reduction value and the output power threshold is further associated with a carrier and a serving cell.

9. The apparatus of claim 1, wherein the processing system is further configured to:
determine a plurality of carrier aggregation (CA) power reduction values that are respectively associated with a plurality of carriers and a plurality of serving cells, wherein the power reduction value is determined based on the plurality of CA power reduction values.

10. The apparatus of claim 1, further comprising:
a second interface configured to obtain, from the network node, information indicating the ID of the at least one of the antenna panel or the beam.

11. The apparatus of claim 10, wherein the information indicating the ID of the at least one of the antenna panel or the beam is obtained based on a user equipment (UE) capability associated with the apparatus.

12. The apparatus of claim 10, wherein the information indicating the ID of the at least one of the antenna panel or the beam is obtained via radio resource control (RRC) signaling.

13. The apparatus of claim 1, wherein the ID of the at least one of the antenna panel or the beam corresponds to at least one of a synchronization signal block (SSB) resource indicator (RI) or a channel state information reference signal (CSI-RS) RI.

14. The apparatus of claim 1, further comprising:
a transmitter configured to transmit the data to the network node based on the output power threshold, wherein the apparatus is configured as a user equipment (UE).

15. An apparatus for wireless communications, comprising:
a processing system configured to determine an identifier (ID) associated with limiting transmission output power of a transmission to be communicated with a user equipment (UE) via at least one of an antenna panel or a beam that corresponds to the ID; and
a first interface configured to output information indicating the ID of the at least one of the antenna panel or the beam for transmission to the UE.

16. The apparatus of claim 15, wherein the information indicating the ID of the at least one of the antenna panel or the beam is output for transmission to the UE via radio resource control (RRC) signaling based on a capability of the UE.

17. The apparatus of claim 15, further comprising:
a second interface configured to obtain, from the UE, a report indicating at least one of an output power threshold upon which the limiting of the transmission power is based or a power reduction value upon which the output power threshold is based, wherein
the processing system is further configured to schedule another transmission by the UE based on the at least one of the output power threshold or the power reduction value.

18. The apparatus of claim 17, wherein the report comprises a power headroom report (PHR) associated with the ID of the at least one of the antenna panel or the beam.

19. The apparatus of claim 15, wherein the ID of the at least one of the antenna panel or the beam corresponds to at least one of a synchronization signal block (SSB) resource indicator (RI) or a channel state information reference signal (CSI-RS) RI.

20. The apparatus of claim 15, further comprising:
a transmitter configured to transmit the information indicating the ID of the at least one of the antenna panel or the beam to the UE, wherein the apparatus is configured as a network node.
